(19) United States
(12) Patent Application Publication
(10) Pub. No.: US 2024/0182704 A1
(43) Pub. Date: Jun. 6, 2024

(54) Compositions Containing Recycled Polymer Materials

(71) Applicant: Celanese International Corporation, Irving, TX (US)

(72) Inventors: Klaus Kurz, Kelsterbach (DE); Kirsten Markgraf, Weinheim (DE)

(21) Appl. No.: 18/511,081

(22) Filed: Nov. 16, 2023

Related U.S. Application Data
(60) Provisional application No. 63/426,444, filed on Nov. 18, 2022.

(51) Int. Cl. C08L 59/02

(52) U.S. Cl. CPC C08L 59/02; C08L 2205/025; C08L 2207/20

(57) ABSTRACT

The present disclosure is directed to a process for recycling polyoxymethylene polymers and to polymer compositions containing the recycled polyoxymethylene polymers. The recycled polyoxymethylene polymers are combined with one or more virgin polyoxymethylene polymers to produce polymer compositions displaying excellent mechanical properties in combination with a high level of stability.

### RELATED APPLICATIONS

The present application is based upon and claims priority to U.S. Provisional Patent Application Ser. No. 63/426,444, having a filing date of Nov. 18, 2022, and which is incorporated herein by reference.

### BACKGROUND

Polyacetal polymers, which are commonly referred to as polyoxymethylenes, have become established as exceptionally useful engineering materials in a variety of applications. Polyoxymethylene polymers, for instance, are widely used in constructing molded parts, such as parts for use in the automotive industry and the electrical industry. Polyoxymethylene polymers, for instance, have excellent mechanical properties, fatigue resistance, abrasion resistance, chemical resistance, and moldability.

Although polyacetal resins possess many useful properties, the polymers have a tendency to degrade when heated and are inherently unstable in an oxidative atmosphere or in an acidic or alkaline environment. In particular, polyacetal resins have a tendency to emit formaldehyde during processing and after the polymer has been molded into a part. Formaldehyde is not only a contaminant, but can also adversely affect metallic components that may be placed in association with the polymer. For example, formaldehyde readily oxidizes to formic acid which can corrode metals or cause discoloration.

In view of the above, the recycling of polyoxymethylene polymers is particularly problematic. In particular, polyoxymethylene polymers are sensitive towards degradation if re-processed multiple times and maintaining required physical and mechanical properties after recycling is challenging. Thus, polyoxymethylene polymers in the form of scrap or used parts can end up in landfills or otherwise disposed of.

Although there is a need in the art to develop a way to recycle or to reuse spent polyoxymethylene polymers, various obstacles exist that have made recycling the polymer problematic. For instance, in order to recycle polyoxymethylene polymers, the polymers need to be heated above their softening temperature in order to melt process the polymers. In fact, in order to recycle polyoxymethylene polymers, the polymers may first need to be melt processed into pellets and then fed to a molding process for producing parts. Reheating and melting the polyoxymethylene polymer multiple times can lead to degradation of the properties of the polymer. In addition, it is believed that reheating the polymers will further degrade their molecular structure causing formaldehyde emissions to increase.

On the other hand, there is increased pressure in the art to lower the carbon footprint of plastic manufacturers and of companies that incorporate polymer components into their products. The ability to recycle polyoxymethylene polymers would decrease the need for fossil-based monomers and would improve the sustainability of the polymers. Recycling is one of the main ways to reduce the consumption of primary resources by replacing them with secondary materials made of recycled waste. Recycling is one of the most desired approaches to achieving sustainability, material self-sufficiency, and the other benefits of a circular economy.

In view of the above, a need currently exists for a process for collecting spent polyoxymethylene polymers and incorporating them into new products. A need also exists for a polymer composition that contains recycled polyoxymethylene polymers.

### SUMMARY

In general, the present disclosure is directed to polyoxymethylene polymer compositions containing recycled polyoxymethylene polymers. In one aspect, the recycled polyoxymethylene polymers are incorporated into the composition in a manner such that the composition can be molded into parts and components that have excellent mechanical and other physical properties in combination with low formaldehyde emissions.

In one aspect, for instance, the present disclosure is directed to a polymer composition comprising a recycled polyoxymethylene polymer. The recycled polyoxymethylene polymer is present in the polymer composition in an amount of at least about 10% by weight, such as in an amount of at least about 15% by weight, such as in an amount of at least about 20% by weight, such as in an amount of at least about 25% by weight, such as in an amount of at least about 30% by weight, such as in an amount of at least about 35% by weight, and generally in an amount less than about 80% by weight, such as in an amount less than about 70% by weight, such as in an amount less than about 60% by weight, such as in an amount less than about 50% by weight, such as in an amount less than about 40% by weight. The recycled polyoxymethylene polymer is combined with a virgin polyoxymethylene polymer. The weight ratio between the virgin polyoxymethylene polymer and the recycled polyoxymethylene polymer can be from about 1:10 to about 10:1, such as from about 2:8 to about 8:2. The recycled polyoxymethylene polymer and the virgin polyoxymethylene polymer can be combined in a manner, in one embodiment, so as to produce a polymer composition that displays a melt flow rate of from about 5 g/10 min to about 40 g/min, a tensile modulus of greater than about 2,550 MPa, a stress at yield of over about 60 MPa, and a formaldehyde emission when tested according to Test VDA-275 of less than about 10 ppm, such as less than about 9 ppm, such as less than about 8 ppm. The formaldehyde emission can be tested, in one aspect, prior to adding any formaldehyde scavengers.

In one aspect, the recycled polyoxymethylene polymer collected and used in the composition of the present disclosure has a relatively low melt flow rate. For instance, the melt flow rate of the recycled polyoxymethylene polymer can be less than about 8 g/10 min, such as less than about 7 g/10 min, such as less than about 6 g/10 min, such as less than about 5 g/10 min, such as less than about 4 g/10 min, such as less than about 3 g/10 min, and generally greater than about 0.01 g/10 min, such as greater than about 0.1 g/10 min.

In another aspect, the recycled polyoxymethylene polymer collected and used in the polymer composition can be non-nucleated, meaning that the polyoxymethylene polymer does not contain any nucleating agents. Alternatively or in addition, the polymer composition can be formulated so as to contain no nucleating agents.

The recycled polyoxymethylene polymer can be a reclaimed polymer comprising scraps from an industrial process or can comprise recycled polyoxymethylene polymers that have been placed in use and collected in the recycle stream.

In one embodiment, the polymer composition of the present disclosure can be formulated to have a melt flow rate of from about 6 g/10 min to about 11 g/10 min, including all increments of 1 g/10 min therebetween. Alternatively, the polymer composition can be formulated to have a melt flow rate of from about 11 g/10 min to about 50 g/10 min, such as from about 12 g/10 min to about 30 g/10 min. In this regard, the virgin polyoxymethylene polymer contained in the polymer composition can have a melt flow rate of anywhere from about 1 g/10 min to about 100 g/10 min. In one embodiment, the virgin polyoxymethylene polymer has a melt flow rate of from about 9 g/10 min to about 20 g/10 min, such as from about 10 g/10 min to about 14 g/10 min. Alternatively, the virgin polyoxymethylene polymer can have a melt flow rate of from about 15 g/10 min to about 50 g/10 min, such as from about 18 g/10 min to about 35 g/10 min.

In order to incorporate the recycled polyoxymethylene polymer into the polymer composition, the recycled polyoxymethylene polymer can first be ground into particles. The ground particles can be then extruded into pellets. The virgin polyoxymethylene polymer can also be in the form of particles and/or pellets. In one aspect, the average particle size of the recycled polyoxymethylene polymer is within about 50%, such as within about 40%, such as within about 30%, such as within about 20%, such as within about 10%, such as within about 5% of the particle size of the virgin polyoxymethylene polymer.

In one aspect, it was unexpectedly discovered that the recycled polyoxymethylene particles can be combined with the virgin polyoxymethylene particles and dry blended prior to being melt processed into polymer components and parts. Alternatively, the recycled polyoxymethylene polymer and the virgin polyoxymethylene polymer can be melt blended together and compounded prior to being fed to a molding process, such as an injection molding, blow molding, or other molding process.

In one aspect, the polymer composition formulated in accordance with the present disclosure can display a tensile modulus of greater than about 2,600 MPa, such as greater than about 2,650 MPa. The stress at yield of the polymer composition can be greater than about 62 MPa, such as greater than about 65 MPa, such as greater than about 67 MPa. In addition, the polymer composition can display a strain at yield of greater than about 8%, such as greater than about 9%.

Various other components and additives can be incorporated into the polymer composition. For instance, in one embodiment, the polymer composition can contain an acid scavenger. The acid scavenger can comprise a metal salt of an organic acid, such as a carboxylic acid. Examples of acid scavengers include tricalcium citrate and calcium stearate.

All different types of articles and products can be made in accordance with the present disclosure. For instance, molded articles made according to the present disclosure can be used in all different types of industrial and consumer products. In one embodiment, the polymer composition can be used to form interior automotive parts. The molded article can comprise a latch, a lever, a gear, a pivot housing, a speaker grill, a door handle, a decorative trim piece, a bracket, a seat rail, or the like.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of the interior of a vehicle including various parts that can be molded in accordance with the present disclosure; and

FIG. 2 is a perspective view of a conveyor system that can include parts made according to the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to incorporating recycled polyoxymethylene polymers into polymer compositions for forming various different molded articles. The recycling of post-consumer and post-industrial polymeric waste can be one of the key platforms in the plastics industry in order to decrease production costs, reduce overall plastic waste, and decrease the carbon footprint of polymeric materials. Although various different types of polymeric materials are commonly recycled, currently no commercial process exists for recycling polyoxymethylene polymers. Polyoxymethylene polymers, for instance, are believed to degrade and/or emit greater amounts of formaldehyde when reheated and remelted. Thus, the recycling of polyoxymethylene polymers has been limited in the past. The present disclosure, however, is directed to recycling polyoxymethylene polymers and incorporating them into a polymer composition that is capable of producing molded parts with excellent mechanical properties. In accordance with the present disclosure, recycled polyoxymethylene polymers are selected having particular characteristics that are then combined with virgin polymers. In this manner, polymer articles can be produced containing recycled polyoxymethylene polymers that can achieve high quality properties for use in high quality applications. In fact, it was unexpectedly discovered that the recycled polyoxymethylene polymers can be dry blended with virgin polyoxymethylene polymers to produce articles with excellent mechanical properties and without having to compound the materials together prior to the molding process, such as an injection molding process.

The recycled polyoxymethylene polymer and the virgin

polyoxymethylene polymer can comprise any suitable polyoxymethylene polymer made according to any suitable process. In one embodiment, both the recycled polyoxymethylene polymer and the virgin polyoxymethylene polymer are made according to the same process. For instance, both polymers can be formed according to a solution hydrolysis process or can be formed according to a melt hydrolysis process.

The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. The polyoxymethylene polymer used in the polymer composition may comprise a homopolymer or a copolymer. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.01 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

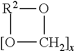

in which x is 0 or 1 and R² is a C₂-C₄-alkylene group which, if appropriate, has one or more substituents which are C₁-C₄-akyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers. It is particularly advantageous to use copolymers composed of from 99.5 to 95 mol. % of trioxane and of from 0.01 to 5 mol. %, such as from 0.5 to 4 mol. %, of one of the above-mentioned comonomers. In one embodiment, the polyoxymethylene polymer contains relatively low amounts of comonomer. For instance, the comonomer can be present in an amount less than about 2 mol. %, such as less than about 1.5 mol. %, such as less than about 1 mol. %, such as less than about 0.8 mol. %, such as less than about 0.6 mol. %.

The polymerization can be effected as precipitation polymerization or in the melt. For example, the polyoxymethylene copolymer can be formed through solution hydrolysis in which a precipitate or powder is formed that has extremely low amounts of unstable end groups. By a suitable choice of the polymerization parameters, such as duration of polymerization or amount of molecular weight regulator, the molecular weight and hence the MVR value of the resulting polymer can be adjusted.

In one embodiment, the polyoxymethylene polymer used in the polymer composition may contain a relatively high amount of reactive groups or functional groups in the terminal positions. The reactive groups, for instance, may comprise —OH or —NH₂ groups.

In one embodiment, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 15 mmol/kg, such as at least 18 mmol/kg, such as at least 20 mmol/kg. In one embodiment, the terminal hydroxyl group content ranges from 18 to 50 mmol/kg. In an alternative embodiment, the polyoxymethylene polymer may contain terminal hydroxyl groups in an amount less than 20 mmol/kg, such as less than 18 mmol/kg, such as less than 15 mmol/kg. For instance, the polyoxymethylene polymer may contain terminal hydroxyl groups in an amount from about 5 mmol/kg to about 20 mmol/kg, such as from about 5 mmol/kg to about 15 mmol/kg. For example, a polyoxymethylene polymer may be used that has a lower terminal hydroxyl group content but has a higher melt volume flow rate.

In addition to or instead of the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O-repeat units.

In one embodiment, a polyoxymethylene polymer can be produced using a cationic polymerization process followed by solution hydrolysis to remove any unstable end groups. During cationic polymerization, a glycol, such as ethylene glycol or methylal can be used as a chain terminating agent. A heteropoly acid, triflic acid or a boron compound may be used as the catalyst.

The polyoxymethylene polymer can have any suitable molecular weight. The molecular weight of the polymer, for instance, can be from about 4,000 grams per mole to about 20,000 g/mol. In other embodiments, however, the molecular weight can be well above 20,000 g/mol, such as from about 20,000 g/mol to about 100,000 g/mol.

In producing polymer compositions of the present disclosure, the recycled polyoxymethylene polymer is first collected and then matched with a virgin polyoxymethylene polymer. The recycled polyoxymethylene polymer can comprise, in one embodiment, “reclaimed” polyoxymethylene polymer scraps. Reclaimed polyoxymethylene polymer represents scraps accumulated during manufacture of various molded articles and can include startup waste, bead, slitter trim, reject parts, and the like. Alternatively, the recycled polyoxymethylene polymer collected can be derived from polyoxymethylene polymer molded parts that were incorporated into products or otherwise used and then collected through a recycle stream.

Once the recycled polymer stock is collected, in one embodiment, the recycled polymer stock may be reduced in size to form particles or chips. For instance, the recycled polyoxymethylene polymer stock may be fed to a grinding device that reduces the polyoxymethylene polymer stock into particles or flakes. In general, any suitable grinding device can be used to reduce the size of the recycled polyoxymethylene polymer.

The particle size of the recycled polyoxymethylene polymer can vary depending upon the particular application. In one embodiment, for instance, the recycled polyoxymethylene polymer can be reduced in size so as to have an average particle size of from about 15 mm to about 1 micron, including all increments of 1 micron therebetween. In one aspect, the recycled polyoxymethylene polymer can have an average particle size of from about 3 mm to about 15 mm, such as from about 5 mm to about 10 mm. In another aspect, the recycled polyoxymethylene polymer can have an average particle size of from about 1 micron to about 3 mm, such as from about 1 micron to about 1 mm. The particle size can be measured using any suitable light scattering device.

The recycled polyoxymethylene polymer can be combined with a virgin polyoxymethylene polymer in form of ground particles or can first be extruded into pellets and combined with virgin polyoxymethylene polymer pellets.

In one embodiment, the particle size of the recycled polyoxymethylene polymer can be matched to the particle size of the virgin polyoxymethylene polymer. For instance, the average particle size of the recycled polyoxymethylene polymer can be within about 50%, such as within about 40%, such as within about 30%, such as within about 20%, such as within about 10%, such as within about 5% of the particle size of the virgin polyoxymethylene polymer.

Prior to combining the recycled polyoxymethylene polymer particles with the virgin polyoxymethylene polymer, the recycled polyoxymethylene polymer can be subjected to various processes for removing any contaminants. For example, in one embodiment, the recycled polyoxymethylene polymer may be washed in an aqueous or non-aqueous solution. For instance, the recycled polyoxymethylene polymer can be washed in water or in a water plus detergent solution in order to remove dirt or otherwise clean the polymer parts and/or particles.

In one aspect, the polyoxymethylene polymer can be ground into particles and washed in a solution capable of removing grease, grime or other non-polymeric elements on the surface of the polymer. For instance, the recycled polyoxymethylene polymers can be washed in an alkaline solution, such as a solution containing caustic soda. In still another embodiment, the recycled polyoxymethylene polymer can be washed in a solvent, such as a hydrocarbon solvent.

Instead of or in addition to a washing step, the recycled

polyoxymethylene polymer can also be subjected to various other processes and methods for removing impurities. For instance, in one embodiment, the recycled polyoxymethylene polymer can be fed through a flotation process or sedimentation process by which heavier or lighter materials are removed. In still other embodiments, the recycled polyoxymethylene polymer can be fed through an electrostatic separating device and/or a magnetic separating device.

In various embodiments, the recycled polyoxymethylene polymer collected in accordance with the present disclosure can be selected so as to have various characteristics. In general, the recycled polyoxymethylene polymer can have a melt flow rate of from about 0.1 g/10 min to about 80 g/10 min, including all increments of 0.5 g/10 min therebetween. As used herein, the melt flow rate or melt flow index of a polyoxymethylene polymer can be determined according to ISO Test 1133 at 190° C. and at a load of 2.16 kg.

In one particular aspect, the recycled polyoxymethylene polymer can have a relatively low melt flow rate. It was discovered that various advantages and benefits can be obtained by combining a relatively low melt flow rate recycled polymer with a virgin polyoxymethylene polymer having a higher melt flow rate. For example, the recycled polyoxymethylene polymer collected in accordance with the present disclosure, in one aspect, can have a melt flow rate of less than about 8 g/10 min, such as less than about 7 g/10 min, such as less than about 6 g/10 min, such as less than about 5 g/10 min, such as less than about 4 g/10 min, such as less than about 2 g/10 min. The melt flow rate of the recycled polyoxymethylene polymer can be greater than about 0.3 g/10 min, such as greater than about 0.5 g/10 min, such as greater than about 0.8 g/10 min, such as greater than about 1 g/10 min, such as greater than about 1.3 g/10 min, such as greater than about 1.5 g/10 min.

Another characteristic that may be beneficial in formulating the polymer composition of the present disclosure is to use recycled polyoxymethylene polymers that are non-nucleated. For instance, the recycled polyoxymethylene polymer may be selected so that the polymer does not contain any nucleating agents, such as an oxymethylene terpolymer or talc particles. Incorporating a non-nucleated recycled polyoxymethylene polymer into the polymer composition has been found to facilitate processing and improve final characteristics.

Once the recycled polyoxymethylene polymer is collected, the recycled polyoxymethylene polymer is combined with a virgin polyoxymethylene polymer in accordance with the present disclosure. The virgin polyoxymethylene polymer is selected so as to produce a polymer composition having desired characteristics, such as melt flow rate, and the like. In accordance with the present disclosure, the recycled polyoxymethylene polymer and the virgin polyoxymethylene polymer are combined in a manner that produces molded articles having excellent mechanical properties. In one aspect, the polymer composition of the present disclosure can also display relatively low formaldehyde emission characteristics.

As described above, in accordance with the present disclosure, the recycled polyoxymethylene polymer is combined with at least one virgin polyoxymethylene polymer. Creating a blend of recycled and virgin materials can be used to control various properties of the resulting polymer composition. For instance, blending the different polymers together can allow for producing polymer compositions with the desired melt flow rate for molding applications, such as injection molding, blow molding, and the like. It was unexpectedly discovered, however, that not only can a polymer composition be produced having a desired melt flow rate, but the resulting polymer composition also has excellent mechanical properties in combination with relatively low formaldehyde emissions.

The amount of virgin polyoxymethylene polymer combined with the recycled polyoxymethylene polymer can depend upon various factors including the resulting desired melt flow rate. The weight ratio between the virgin polyoxymethylene polymer and the recycled polyoxymethylene polymer can be from about 10:1 to about 1:10, such as from about 10:1 to about 1:1, such as from about 4:1 to about 3:2.

The melt flow rate of the virgin polyoxymethylene polymer can generally be from about 1 g/10 min to about 100 g/10 min, including all increments of 0.5 g/10 min therebetween. In one embodiment, when the recycled polyoxymethylene polymer has a melt flow rate of less than about 5 g/10 min, the virgin polyoxymethylene polymer can have a melt flow rate of generally greater than about 9 g/10 min, such as from about 9 g/10 min to about 50 g/10 min. For instance, in one embodiment, the virgin polyoxymethylene polymer can have a melt flow rate of from about 9 g/10 min to about 18 g/10 min, such as from about 11 g/10 min to about 15 g/10 min.

In one aspect, the melt flow rate of the virgin polyoxymethylene polymer can be greater than about 15 g/10 min, such as from about 15 g/10 min to about 50 g/10 min. For instance, the melt flow rate of the virgin polyoxymethylene polymer can be greater than about 18 g/10 min, such as greater than about 20 g/10 min, such as greater than about 22 g/10 min, such as greater than about 25 g/10 min, and generally less than about 45 g/10 min, such as less than about 40 g/10 min, such as less than about 30 g/10 min, such as less than about 29 g/10 min.

The virgin polyoxymethylene polymer can be a polyoxymethylene homopolymer or a polyoxymethylene copolymer. The polyoxymethylene copolymer, for instance, may contain dioxolane as a copolymer. In one embodiment, the virgin polyoxymethylene polymer can have relatively high amounts of comonomer, such as greater than about 1 mol %, such as greater than about 2 mol %, such as greater than about 3 mol %, such as greater than about 4 mol %, such as greater than about 5 mol %, such as greater than about 6 mol %, and generally less than about 8 mol %, such as less than about 6 mol %, such as less than about 5 mol %.

The virgin polyoxymethylene polymer can be in the form of particles, including pellets. The particles can have any suitable size. In one aspect, the virgin polyoxymethylene polymer has a particle size that is found to be compatible with the particle size of the recycled polyoxymethylene polymer. In other embodiments, the virgin polyoxymethylene polymer is in the form of pellets and the recycled polyoxymethylene polymer is ground or pelletized to a size that is compatible with the pellets. The pellets, for instance, can have an average particle size of greater than about 1 mm, such as greater than about 1.5 mm, such as greater than about 2 mm, such as greater than about 2.5 mm, and generally less than about 5 mm, such as less than about 4 mm, such as less than about 3.5 mm.

The polyoxymethylene polymer of the present disclosure can be used in neat form or can be combined with various additives and components. For instance, in one embodiment, the polyoxymethylene polymer can be combined with a tribological modifier.

For example, ultra-high molecular weight silicone (UHMW-Si) may be used to modify the polyoxymethylene polymer. In general, the UHMW-Si can have an average molecular weight of greater than 100,000 g/mol, such as greater than about 200,000 g/mol, such as greater than about 300,000 g/mol, such as greater than about 500,000 g/mol and less than about 3,000,000 g/mol, such as less than about 2,000,000 g/mol, such as less than about 1,000,000 g/mol, such as less than about 500,000 g/mol, such as less than about 300,000 g/mol. Generally, the UHMW-Si can have a kinematic viscosity at 40° C. measured according to DIN 51562 of greater than 100,000 mm²s⁻¹, such as greater than about 200,000 mm²s⁻¹, such as greater than about 1,000,000 mm²s⁻¹, such as greater than about 5,000,000 mm²s⁻¹, such as greater than about 10,000,000 mm²s⁻¹, such as greater than about 15,000,000 mm²s⁻¹ and less than about 50,000,000 mm²s⁻¹, such as less than about 25,000,000 mm²s⁻¹, such as less than about 10,000,000 mm²s⁻¹, such as less than about 1,000,000 mm²s⁻¹, such as less than about 500,000 mm²s⁻¹, such as less than about 200,000 mm²s⁻¹.

In still another embodiment, the tribological modifier may comprise a polytetrafluoroethylene. The polytetrafluoroethylene may be in the form of a powder and can be present in the polymer composition in an amount from about 1% to about 10% by weight.

According to the present disclosure, various other tribological modifiers may be incorporated into the polyoxymethylene polymer composition. These tribological modifiers may include, for instance, calcium carbonate particles, ultrahigh-molecular-weight polyethylene (UHMW-PE) particles, stearyl stearate particles, silicone oil, a polyethylene wax, an amide wax, wax particles comprising an aliphatic ester wax comprised of a fatty acid and a monohydric alcohol, a graft copolymer with an olefin polymer as a graft base, or a combination thereof. These tribological modifiers include the following:
(1) From 0.1-50 wt. %, such as from 1-25 wt. %, of a calcium carbonate particle such as a calcium carbonate (chalk) powder.
(2) From 0.1-50 wt. %, such as from 1-25 wt. %, such as from 2.5-20 wt. %, such as from 5 to 15 wt. %, of an ultrahigh-molecular-weight polyethylene (UHMW-PE) powder. UHMW-PE can be employed as a powder, in particular as a micro-powder. The UHMW-PE generally has a mean particle diameter D₅₀ (volume based and determined by light scattering) in the range of 1 to 5000 μm, preferably from 10 to 500 μm, and particularly preferably from 10 to 150 μm such as from 30 to 130 μm, such as from 80 to 150 μm, such as from 30 to 90 μm.

The UHMW-PE can have an average molecular weight of higher than 1.0·10⁶ g/mol, such as higher than 2.0·10⁶ g/mol, such as higher than 4.0·10⁶ g/mol, such as ranging from 1.0·10⁶ g/mol to 15.0·10⁶ g/mol, such as from 3.0·10⁶ g/mol to 12.0·10⁶ g/mol, determined by viscosimetry. Preferably, the viscosity number of the UHMW-PE is higher than 1000 ml/g, such as higher than 1500 ml/g, such as ranging from 1800 ml/g to 5000 ml/g, such as ranging from 2000 ml/g to 4300 ml/g (determined according to ISO 1628, part 3; concentration in decahydronaphthalin: 0.0002 g/ml).
(3) From 0.1-10 wt. %, such as from 0.1-5 wt. %, such as from 0.5-3 wt. %, of stearyl stearate.
(4) From 0.1-10 wt. %, such as from 0.5-5 wt. %, such as from 0.8-2 wt. %, of a silicone oil. Alternatively, in one embodiment, the composition may be substantially free of silicone oil, such that the silicone oil is present in an amount of less than about 0.1 wt. %, such as less than about 0.05 wt. %, such as less than about 0.01 wt. %, such as about 0 wt. %.
(5) From 0.1-5 wt. %, such as from 0.5-3 wt. %, of a polyethylene wax, such as an oxidized polyethylene wax.
(6) From 0.1-5 wt. %, such as from 0.2-2 wt. %, of an amide wax.
(7) From 0.1-5 wt. %, such as from 0.5-3 wt. %, of an aliphatic ester wax composed of a fatty acid and of a monohydric alcohol.

The polymer composition of the present disclosure may also contain other known additives such as, for example, antioxidants, formaldehyde scavengers, acid scavengers, UV stabilizers or heat stabilizers, reinforcing fibers. In addition, the compositions can contain processing auxiliaries, for example adhesion promoters, lubricants, nucleants, demolding agents, fillers, or antistatic agents and additives which impart a desired property to the compositions and articles or parts produced therefrom.

In one embodiment, an ultraviolet light stabilizer may be present. The ultraviolet light stabilizer may comprise a benzophenone, a benzotriazole, or a benzoate. The UV light absorber, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a formaldehyde scavenger, such as a nitrogen-containing compound, may be present. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Other particularly advantageous compounds are triamino-1,3,5-triazine (melamine) and its derivatives, such as melamine-formaldehyde condensates and methylol melamine. Oligomeric polyamides are also suitable in principle for use as formaldehyde scavengers. The formaldehyde scavenger may be used individually or in combination.

Further, the formaldehyde scavenger may be a guanamine compound which may include an aliphatic guanamine-based compound, an alicyclic guanamine-based compound, an aromatic guanamine-based compound, a hetero atom-containing guanamine-based compound, or the like. Other formaldehyde scavengers that may be used include hydantoin, a substituted hydantoin, allantoin, a hydrazide such as an aliphatic carboxylic hydrazide, an amino acid such as arginine, an alkylene urea such as ethylene urea, and mixtures thereof. The formaldehyde scavenger may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, an acid scavenger may be present. In one particular embodiment, for instance, the acid scavenger can comprise a metal salt of an organic acid, wherein the organic acid has a carbon chain length of 8 carbon atoms or less. For example, in one particular embodiment, the acid scavenger can comprise a metal citrate, such as tricalcium citrate.

In other embodiments, the acid scavenger can comprise a salt of a carboxylic acid, such as a metal salt of a fatty acid. The carboxylic acid salt may comprise an alkaline earth metal salt, for instance, of a fatty acid. The cation of the salt, for instance, may comprise calcium, barium, lithium, sodium, magnesium, zinc, or the like.

The fatty acid can contain a carbon chain length of generally from about 3 carbon atoms to about 20 carbon atoms. The fatty acid may comprise a dicarboxylic acid or a tricarboxylic acid. Particular examples include metal salts of propionic acid, stearic acid, butanoic acid, hexanoic acid, decanoic acid, lauric acid, myristic acid, palmitic acid, and the like. Particular examples include calcium propionate, calcium 12-hydroxystearate, calcium stearate, and mixtures thereof.

One or more acid scavengers can be present in the polymer composition generally in an amount from about 0.05% by weight to about 2% by weight, including all increments of 0.1% by weight therebetween. In some embodiments, especially when using tricalcium citrate, relatively small amounts of an acid scavenger are needed. For instance, the acid scavenger can be present in an amount less than 1% by weight, such as less than about 0.8% by weight, such as less than about 0.5% by weight, such as less than about 0.2% by weight, such as even in an amount less than about 0.08% by weight. One or more acid scavengers are generally present in an amount greater than 0.001% by weight, such as in an amount greater than about 0.01% by weight.

In one embodiment, a nucleant may be present. As described above, in one aspect, the recycled polyoxymethylene polymer may be selected such that the recycled polymer does not contain any nucleants. After the recycled polyoxymethylene polymer is combined with the virgin polyoxymethylene polymer, a nucleant may optionally be included in the polymer composition. The nucleant may increase crystallinity and may comprise an oxymethylene terpolymer. In one particular embodiment, for instance, the nucleant may comprise a terpolymer of butanediol diglycidyl ether, ethylene oxide, and trioxane. The nucleant may be present in the composition in an amount of at least about 0.01 wt. %, such as at least about 0.05 wt. %, such as at least about 0.1 wt. % and less than about 2 wt. %, such as less than about 1.5 wt. %, such as less than about 1 wt. %, wherein the weight is based on the total weight of the respective polymer composition.

In one embodiment, an antioxidant, such as a sterically hindered phenol, may be present. Examples which are available commercially, are pentaerythrityl tetrakis[3-(3,5-di-tert-butyl-4-hydroxyphenyl)propionate], triethylene glycol bis[3-(3-tert-butyl-4-hydroxy-5-methylphenyl)propionate], 3,3′-bis[3-(3,5-di-tert-butyl-4-hydroxyphenyl)propionohydrazide], and hexamethylene glycol bis[3-(3,5-di-tert-butyl-4-hydroxyphenyl)propionate]. The antioxidant may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a light stabilizer, such as a sterically hindered amine, may be present in addition to the ultraviolet light stabilizer. Hindered amine light stabilizers that may be used include oligomeric hindered amine compounds that are N-methylated. For instance, hindered amine light stabilizer may comprise a high molecular weight hindered amine stabilizer. The light stabilizers, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a lubricant, not including the tribological modifiers mentioned above, may be present. The lubricant may comprise a polymer wax composition. Further, in one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. In another embodiment, a fatty acid amide such as ethylene bis(stearamide) may be present. Lubricants may generally be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a colorant may be present. In one aspect, one or more colorants may be incorporated into the polymer composition such that the resulting composition displays a single shade of color. In particular, one or more coloring agents can be added so that the recycled polyoxymethylene polymer and the virgin polyoxymethylene polymer display a single color when melted and formed into a molded article. Colorants that may be used include any desired inorganic pigments, such as titanium dioxide, ultramarine blue, cobalt blue, and other organic pigments and dyes, such as phthalocyanines, anthraquinnones, and the like. Other colorants include carbon black or various other polymer-soluble dyes. The colorant may be present in the composition in an amount of at least about 0.01 wt. %, such as at least about 0.05 wt. %, such as at least about 0.1 wt. % and less than about 5 wt. %, such as less than about 2.5 wt. %, such as less than about 1 wt. %, wherein the weight is based on the total weight of the respective polymer composition.

In one embodiment, a reinforcing fiber may be present. The reinforcing fibers which may be used according to the present invention include mineral fibers, glass fibers, polymer fibers such as aramid fibers, metal fibers such as steel fibers, carbon fibers, or natural fibers. These fibers may be unmodified or modified, e.g. provided with a sizing or chemically treated, in order to improve adhesion to the polymer. Fiber diameters can vary depending upon the particular fiber used and whether the fiber is in either a chopped or a continuous form. The fibers, for instance, can have a diameter of from about 5 μm to about 100 μm, such as from about 5 μm to about 50 μm, such as from about 5 μm to about 15 μm. When present, the respective composition may contain reinforcing fibers in an amount of at least 1 wt. %, such as at least 5 wt. %, such as at least 7 wt. %, such as at least 10 wt. %, such as at least 15 wt. % and generally less than about 50 wt. %, such as less than about 45 wt. %, such as less than about 40 wt. %, such as less than about 30 wt. %, such as less than about 20 wt. %, wherein the weight is based on the total weight of the respective polyoxymethylene polymer composition.

The polymer composition may also comprise an impact modifier such as a thermoplastic elastomer. Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE-E), thermoplastic polyamide elastomers (TPE-A) and in particular thermoplastic polyurethane elastomers (TPE-U).

Alternatively, the impact modifier can be core-shell type impact modifier. For example, the impact modifier can comprise metacrylate-butadiene-styrene copolymer particles.

The amount of thermoplastic elastomer contained in the polymer composition can vary depending upon various factors. For instance, the thermoplastic elastomer can be present in an amount ranging from about 0.5% by weight to about 50% by weight. In one embodiment, for instance, a thermoplastic elastomer or impact modifier may be present in the composition in an amount less than about 25% by weight, such as in an amount less than about 15% by weight, such as in an amount less than about 10% by weight. The thermoplastic elastomer or impact modifier is generally present in an amount greater than about 2% by weight, such as in an amount greater than about 5% by weight, such as in an amount greater than about 8% by weight, such as in an amount greater than about 10% by weight.

The polymer composition of the present disclosure can be used to produce various molded parts. The parts can be formed through any suitable molding process, such as an injection molding process or through a blow molding process. Polymer articles that may be made in accordance with the present disclosure include knobs, door handles, automotive decorative trim pieces, and the like without limitation. Other polymer articles, for instance, that may be made in accordance with the present disclosure include latches, levers, gears, pivot housings, speaker grills, and the like.

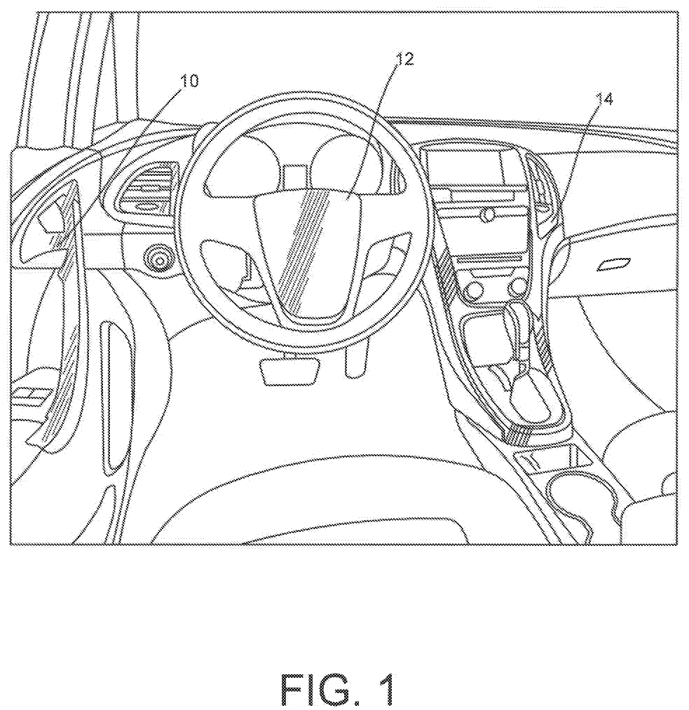

In one aspect, the polymer composition of the present disclosure can be used to produce an interior automotive component. For instance, referring to FIG. 1, an automotive interior is shown illustrating various automotive parts that may be made in accordance with the present disclosure. The polymer composition, for instance, may be used to produce automotive part 10, which comprises at least a portion of an interior door handle. The polymer composition may also be used to produce a part on the steering column such as automotive part 12. In general, the polymer composition can be used to mold any suitable decorative trim piece or bezel, such as trim piece 14.

In one embodiment, polymer articles made in accordance with the present disclosure can be used to make components of a conveyor system. Conveyor systems, for instance, typically include a conveyor chain that moves over a track. Such conveyor systems can be used to move all different types of products and goods. In one embodiment, for instance, such conveyors are used to transport food products.

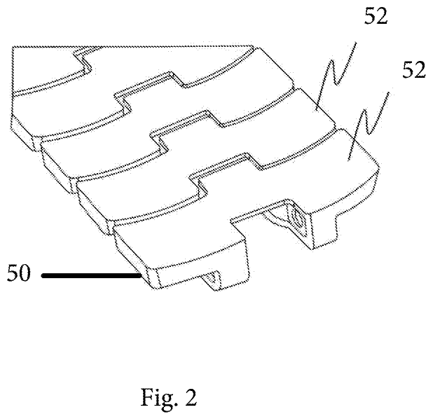

Referring to FIG. 2, for instance, one embodiment of a portion of a conveyor chain 50 is illustrated. As shown, the conveyor chain 50 is made from a plurality of conveyor components 52 or links. Each of the conveyor components 52 includes a top surface for receiving and transporting food products. In accordance with the present disclosure, the conveyor component 52 can be made from the polymer composition of the present disclosure. Of particular advantage, the conveyor component 52 can include one or more coloring agents that provide the components with a desired surface appearance. Advantageously, components comprising compositions prepared according to the present disclosure may exhibit low formaldehyde emission and extraction when exposed to harsh cleaning conditions.

The present disclosure may be better understood with reference to the following examples.

### Example No. 1

During this example, various polymer compositions were formulated and tested for mechanical properties. All of the tensile test properties were tested according to ISO Test 527-2/1A (most current test). The Charpy notched impact resistance test was tested according to ISO Test 179/1eA (most current test). The formaldehyde emission test used was VDA Test 275 (German Automotive Industry Recommendation No. 275) and is documented by Kraftfahrwesen e. V., July 1994. The VDA test specimens had a thickness of 2 mm and were molded at 185 degrees C.

Recycled polyoxymethylene polymer was collected, ground into particles, extruded into pellets, and then molded into test specimens for measuring various physical properties. The following results were obtained:

TABLE NO. 1

| | | Sample No. 1 | Sample No. 2 |
|---|---|---|---|
| Charpy Notched Impact | kJ/m² | 8.8 | 8.5 |
| Strength | | | |
| Tensile Modulus | MPa | 2377 | 2311 |
| Stress at break | MPa | 45 | 42 |
| Strain at break | % | 36 | 36 |
| MVR (190° C., 2.16 kg) | cm³/10 min. | 2.8 | 2.8 |
| VDA 275 | ppm | 7.8 | 7.6 |
| Crystallization half time | sec. | 250 | 610 |
| T_{C} (DSC) | ° C. | 147.8 | 146.6 |
| T_{M} (DSC) | ° C. | 164.4 | 163.2 |
| enthalpy | J/g | 160 | 159 |

As shown above, the recycled polyoxymethylene polymer collected had a relatively low melt flow rate.

The recycled polyoxymethylene polymer samples described above were then combined with a virgin polyoxymethylene polymer. In a first set of experiments, the virgin polyoxymethylene polymer blended with the recycled polyoxymethylene polymer was a copolymer and had a melt flow rate of about 12.5 g/10 min (ISO Test 1133, 190 C, 2.16 kg). The virgin polymer had the following characteristics:

| Tensile modulus | 2900 | MPa | ISO 527-1, -2 |
|---|---|---|---|
| Tensile stress at yield, 50 mm/min | 65 | MPa | ISO 527-1, -2 |
| Tensile strain at yield, 50 mm/min | 9% | | ISO 527-1, -2 |
| Flexural modulus, 23° C. | 2750 | MPa | ISO 178 |
| Charpy notched impact strength, 23° C. | 6.5 | kJ/m² | ISO 179/1eA |

The virgin polyoxymethylene polymer was combined with the recycled polyoxymethylene polymer at a weight ratio of 80:20 or 60:40. In particular, Sample Nos. 3, 5, 7, 9, and 11 below had a weight ratio of virgin polyoxymethylene polymer to recycled polyoxymethylene polymer of 80:20 and Sample Nos. 4, 6, 8, 10, and 12 below had a weight ratio of virgin polyoxymethylene polymer to recycled polyoxymethylene polymer of 60:40.

In some of the experiments, the recycled polyoxymethylene polymer was melt blended or compounded with the virgin polyoxymethylene polymer. In another set of experiments, the two different polymers were dry blended.

The compositions were formulated and tested for various physical properties. The virgin polyoxymethylene polymer was combined with the recycled polyoxymethylene polymer in order to reach a desired resulting melt flow rate of from about 6 g/10 min to about 9 g/10 min. The following results were obtained. In Sample Nos. 3-6, recycled polyoxymethylene polymer Sample No. 1 was used. In Sample Nos. 7 and 8, on the other hand, recycled polyoxymethylene polymer Sample No. 2 was used.

TABLE NO. 2

| | | Sample | Sample | Sample | Sample | Sample | Sample |
|---|---|---|---|---|---|---|---|
| | | No. 3 | No. 4 | No. 5 | No. 6 | No. 7 | No. 8 |
| | | Compound | | Dry Blend | | Compound | |
| Charpy Notched | KJ/m² | 6.6 | 7.3 | 6.9 | 7.7 | 6.2 | 6.4 |
| Impact Strength | (23 C) | | | | | | |
| Tensile Modulus | MPa | 2661 | 2610 | 2666 | 2618 | 2674 | 2608 |
| Stress at yield | MPa | 62.58 | 61.73 | 62.88 | 62.13 | 62.56 | 61.27 |
| Strain at yield | % | 9.82 | 10.00 | 9.50 | 9.81 | 9.64 | 9.60 |
| MVR (190° C., | cm³/ | 8.98 | 6.38 | 9.00 | 6.62 | 8.61 | 6.07 |
| 2.16 kg) | 10 min. | | | | | | |
| VDA 275 | ppm | 6.46 | 7.07 | 6.22 | 6.52 | 5.97 | 8.27 |
| T_{C} (DSC) | ° C. | 147.1 | 147.0 | 147.4 | 146.9 | 146.5 | 146.1 |
| T_{M} (DSC) | ° C. | 165.7 | 165.2 | 165.7 | 165.5 | 165.9 | 165.3 |

Another set of polymer compositions were formulated using recycled polyoxymethylene polymer Sample No. 1 and Sample No. 2 above. In the following set of experiments, the virgin polyoxymethylene polymer had a melt flow rate of about 27 g/10 min and had a relatively high comonomer content. The virgin polymer had the following characteristics:

| Tensile modulus | 2900 | MPa | ISO 527-1, -2 |
|---|---|---|---|
| Tensile stress at yield, 50 mm/min | 65 | MPa | ISO 527-1, -2 |
| Tensile strain at yield, 50 mm/min | 7.5% | | ISO 527-1, -2 |
| Flexural modulus, 23° C. | 2750 | MPa | ISO 178 |
| Charpy notched impact strength, 23° C. | 5.5 | kJ/m² | ISO 179/1eA |

In Sample Nos. 9 and 10 below, recycled polyoxymethylene polymer Sample No. 1 was used. In Sample Nos. 11 and 12 below, recycled polyoxymethylene polymer Sample No. 2 was used. The following results were obtained.

TABLE NO. 3

| | | Sample | Sample | Sample | Sample |
|---|---|---|---|---|---|
| | | No. 9 | No. 10 | No. 11 | No. 12 |
| Charpy Notched Impact | kJ/m² | 5.9 | 6.4 | 5.7 | 6.0 |
| Strength | (23 C.) | | | | |
| Tensile Modulus | MPa | 2625 | 2585 | 2644 | 2585 |
| Stress at yield | MPa | 61.42 | 60.89 | 61.55 | 60.63 |
| Strain at yield | % | 8.54 | 9.18 | 8.48 | 8.99 |
| MVR (190° C., | cm³/ | 14.54 | 8.82 | 13.87 | 8.48 |
| 2.16 kg) | 10 min | | | | |
| VDA 275 | ppm | 3.96 | 5.68 | 4.29 | 4.22 |
| T_{C} (DSC) | ° C. | 145.8 | 145.5 | 145.7 | 145.7 |
| T_{M} (DSC) | ° C. | 164.8 | 164.9 | 164.5 | 164.2 |

As shown above, polymer compositions according to the present disclosure can display a formaldehyde emission of less than about 10 ppm, such as less than about 9 ppm, such as less than about 8 ppm, such as less than about 7 ppm, such as less than about 6 ppm, such as less than about 5 ppm, such as even less than about 4 ppm. These results can be obtained without adding any new or additional formaldehyde scavengers (e.g. formaldehyde scavengers not already compounded with the polymers).

The polymer compositions can also display a tensile modulus of greater than about 2,550 MPa, such as greater than about 2,600 MPa, and generally less than about 5,000 MPa. The stress at yield can be greater than about 60 MPa, such as greater than about 61 MPa, such as greater than about 62 MPa, and generally less than about 80 MPa. The strain at yield can be greater than about 8%, such as greater than about 8.5%, such as greater than about 9%, such as greater than about 9.5%, and generally less than about 15%. The Charpy notched impact strength at 25° C. can be greater than about 5.5 KJ/m², such as greater than about 6 KJ/m², such as greater than about 6.5 KJ/m², such as greater than about 7 KJ/m², and generally less than about 18 KJ/m². Many of these results are unexpected and surprising.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a recycled polyoxymethylene polymer, wherein the recycled polyoxymethylene polymer is contained in the polymer composition in an amount of at least about 10% by weight;
a virgin polyoxymethylene polymer combined with the recycled polyoxymethylene polymer; and
wherein the polymer composition displays a melt flow rate of from about 5 g/10 min to about 40 g/10 min, a tensile modulus of greater than about 2,550 MPa, a stress at yield of over about 60 MPa, and a formaldehyde emission when tested according to Test VDA-275 of less than about 10 ppm.

2. A polymer composition as defined in claim 1, wherein the recycled polyoxymethylene polymer has a melt flow rate of less than about 10 g/10 min.

3. A polymer composition as defined in claim 1, wherein the polymer composition has a melt flow rate of from about 6 g/10 min to about 12 g/10 min.

4. A polymer composition as defined in claim 1, wherein the recycled polyoxymethylene polymer and the virgin polyoxymethylene polymer are dry blended only prior to being formed into polymer articles.

5. A polymer composition as defined in claim 1, wherein the recycled polyoxymethylene polymer and the virgin polyoxymethylene polymer are melt blended and formed into pellets prior to being melt processed into polymer articles.

6. A polymer composition as defined in claim 1, wherein the polymer composition displays a strain at yield of greater than about 8%.

7. A polymer composition as defined in claims 1, wherein the virgin polyoxymethylene polymer has a melt flow rate of greater than about 20 g/10 min and less than about 50 g/10 min.

8. A polymer composition as defined in claims 1, wherein the virgin polyoxymethylene polymer has a melt flow rate of from about 8 g/10 min to about 20 g/10 min.

9. A polymer composition as defined in claim 1, wherein the polymer composition displays a formaldehyde emission according to Test VDA-275 of less than about 9 ppm.

10. A polymer composition as defined in claim 1, wherein the recycled polyoxymethylene polymer comprises a reclaimed polyoxymethylene polymer.

11. A polymer composition as defined in claim 1, wherein the recycled polyoxymethylene polymer has been ground into particles.

12. A polymer composition as defined in claim 1, wherein the virgin polyoxymethylene polymer combined with the recycled polyoxymethylene polymer comprises pellets.

13. A polymer composition as defined in claim 1, wherein the recycled polyoxymethylene polymer has a melt flow rate that is less than a melt flow rate of the virgin polyoxymethylene polymer.

14. A polymer composition as defined in claim 1, wherein the polymer composition further comprises an acid scavenger.

15. A polymer composition as defined in claim 14, wherein the acid scavenger comprises tricalcium citrate, calcium stearate, or mixtures thereof.

16. A polymer composition as defined in claim 1, wherein the polymer composition further contains reinforcing fibers in an amount from about 3% by weight to about 40% by weight.

17. A molded article made from the polymer composition as defined in claim 1.

18. A molded article as defined in claim 17, wherein the molded article comprises an interior automotive part.

19. A molded article as defined in claim 17, wherein the molded article comprises a latch, a lever, a gear, a pivot housing, a speaker grill, a door handle, a decorative trim piece, a bracket, or a rail seat.
